(19) United States
(12) Patent Application Publication
(10) Pub. No.: US 2023/0194249 A1
(43) Pub. Date: Jun. 22, 2023

(54) THREE-DIMENSIONAL MEASUREMENT METHOD AND SYSTEM FOR MODULATING THREE-DIMENSIONAL CODES ON PERIODIC EDGES

(71) Applicant: GUANGDONG UNIVERSITY OF TECHNOLOGY, Guangzhou (CN)

(72) Inventors: Jian GAO, Guangzhou (CN); Guixin ZHANG, Guangzhou (CN); Lanyu ZHANG, Guangzhou (CN); Haixiang DENG, Guangzhou (CN); Yun CHEN, Guangzhou (CN); Yunbo HE, Guangzhou (CN); Xin CHEN, Guangzhou (CN)

(21) Appl. No.: 18/062,958

(22) Filed: Dec. 7, 2022

(30) Foreign Application Priority Data
Dec. 20, 2021 (CN) 202111567230.2

(51) Int. Cl. G01B 11/25

(52) U.S. Cl. CPC G01B 11/254

(57) ABSTRACT

A three-dimensional measuring method and system for modulating three-dimensional codes at periodic edges are disclosed, the method includes: step A according to a number of phase levels and a composition rule of the three-dimensional codes, converting the number of phase levels into three-dimensional codes, modulating the three-dimensional codes to periodic edges; step B generating N pieces of modulated three-dimensional codes on periodic edges to form a sinusoidal fringe pattern, according to a N-step phase shift method; step C projecting N pieces of fringe patterns to a surface of an object, collecting the deformed N pieces of fringe patterns on the object surface; step D solving a wrapping phase and a mean intensity of N pieces of fringe patterns; step E since the mean intensities of the adjacent periodic edge codes are different, extracting edge coordinates from the mean intensities by using an edge extraction method.

### CROSS REFERENCE TO RELATED APPLICATIONS

This application claims foreign priority of Chinese Patent Application No. 202111567230.2, filed on Dec. 20, 2021 in the China National Intellectual Property Administration, the disclosures of all of which are hereby incorporated by reference.

### TECHNICAL FIELD

The present application relates to a technical field of optical three-dimensional measurement, especially relates to a three-dimensional measuring method and system for modulating three-dimensional codes on periodic edges.

### BACKGROUND

The structural light measuring technology has advantages of non-contact, full-field loss-free measurement, high precision, fast speed and so on, has been widely applied in various fields such as the industrial detection, machine vision, digitalized artefact and medicine. In the prior arts, a structural light measuring system composed of one camera and one projector has became commonplace since it has simple structure, high efficiency of point cloud reconstruction etc. During the process of measurement, a typical single-camera structural light three-dimensional measuring system has a projection device configured for projecting fringe patterns onto a surface of a target object, and while a camera configured for photographing deformed fringe patterns resulting from modulated height of the target object, and then processing the deformed fringe patterns, calculating a phase information representing the actual height of the object, finally, according to the phase information and identified system parameters, obtaining the three-dimensional information of the object based on the triangular principle.

The three-dimensional measurement of the structural light is mainly divided into two steps, that is, solving the phase unwrapping and solving the absolute phase. According to the different principle of solving the absolute phase, the solving method of the absolute phase can be divided into a temporal phase unwrapping method, a spatial phase unwrapping method, a geometric constraint phase unwrapping method. The spatial phase unwrapping method needs small number of projecting patterns, which is applicable to measurement of dynamic scenes, however the precision of the phase solution is relatively low. The geometric constraint phase unwrapping method can overcome the above shortage of the low precision of the spatial phase unwrapping method, however, it is necessary to add the additional camera device to assist unwrapping. The temporal phase unwrapping method having advantages of high precision, strong robustness, wide adaptability and simple device, has became commonplace, but the traditional temporal phase unwrapping method such as the multi-frequency heterodyne method, the phase coding method, the Gray-coding method and so on, needs to project a large amount of fringe patterns, increasing the time for unwrapping, and the result is sensitive to the movement of the object. Therefore, in order to realize the three-dimensional measurement with high speed and high precision, realizing the number of projected patterns needed for phase unwrapping is always the emphasis for researching the stripe-pattern phase shift profilometry.

### SUMMARY

In order to overcome the defect as aforementioned, the purpose of the present application is to provide a three-dimensional measuring method and system for modulating three-dimensional codes on periodic edges, by extracting the periodic edge coordinate and decoding the left and right edge three-dimensional encryption to determining each stripe lever of each pixel, calculating the absolute phase by each pixel to realize using a small amount of patterns to finish the three-dimensional measurement; the method has less number of fringe patterns, that is, one third of projected patterns compared to the conventional N-phase shift method combined with the three-frequency heterodyne method for unwrapping phase, also, half of projected number compared to the phase-shift coding method, has fast phase-shift speed and high efficiency of point cloud reconstruction.

In order to achieve this purpose, the present application adopts the following technical solution:

A three-dimensional measuring method for modulating three-dimensional codes at periodic edges, comprising the following steps:

Step A: according to a number of phase levels and a composition rule of the three-dimensional codes, converting the number of phase levels into three-dimensional codes, modulating the three-dimensional codes to periodic edges;

Step B: generating N pieces of modulated three-dimensional codes on periodic edges to form a sinusoidal fringe pattern, according to a N-step phase shift method;

Step C: projecting and generating N pieces of fringe patterns to a surface of an object, collecting the deformed N pieces of fringe patterns on the surface of the object;

Step D: solving a wrapping phase and a mean intensity of collected N pieces of fringe patterns according to the N-step phase shift method;

Step E: according to a feature that the mean intensities of the adjacent periodic edges are different, extracting all edge coordinates from the mean intensities by using an edge extraction method;

Step F: using the three-dimensional codes of a left edge and a right edge to determine each stripe level of each pixel of the wrapping phase, unwrapping the pixel by pixel to obtain an absolute phase;

Step G: reconstructing a three-dimensional point cloud according to a triangular distance measurement to establish a three-dimensional model of the object.

In an embodiment, in the step A, the method comprises:

In projected N pieces of fringe patterns, the pixel of each period edge has N values accordingly, each value is 0 or 255, to determine outliers from the N values.

Determining sequence types of the periodic edge codes by using outlier sequence numbers according to the outliers and positions of the outliers located in the sequences of the periodic edge codes.

In an embodiment, when the outlier is 0, the periodic edge is 1 type, when the outlier is 1, the periodic edge is 0 type.

In an embodiment, the code sequences of adjacent periodic edges of a certain pixel are different, thus combination types of left and right periodic edges of the pixel are 0 type and 1 type, or 1 type and 0 type.

In which, the outlier sequence number is 1 type, representing the position of the outlier in the sequence of the periodic edge code, amount to N kinds.

The outlier sequence number is 0 type, representing systems, amount to N systems.

The outlier sequence number is N type representing N times of N systems, namely, by using the three-dimensional coding method, the periodic edge is divided into 2 types.

In an embodiment, in the step B, by using the N-step phase shift method to generate N pieces of modulated three-dimensional codes on the periodic edges to form the sinusoidal fringe pattern, comprising:

Referring to formulas one to five sequentially representing projected fringe patterns, stripe levels, sequence types of periodic edge code values, the outlier sequence numbers and periodic edge code values.

$${I}_{n} ( u , v ) = \{ \begin{matrix}A + B cos [ φ ( u , v ) + \frac{2 n π}{N} ] & mod [ φ ( u , v ) , 2 π ] \neq 0 \\ {m}_{n} ( u , v ) & mod [ φ ( u , v ) , 2 π ] = 0\end{matrix} ; \qquad formula one$$

$$k ( u , v ) = Floor ( \frac{u}{P} ) ; \qquad formula two$$

$$D ( u , v ) = mod [ k ( u , v ) , 2 ] ; \qquad formula three$$

$$O ( u , v ) = \{ \begin{matrix}mod \{ \frac{k ( u , v ) - 1}{2} , N \} & D ( u , v ) = 1 \\ Floor [ \frac{k ( u , v )}{2 N} ] & D ( u , v ) = 0\end{matrix} ; \qquad formula four$$

$${m}_{n} ( u , v ) = \{ \begin{matrix}255 \times [ 1 - D ( u , v ) ] & n = O ( u , v ) \\ 255 \times D ( u , v ) & else\end{matrix} ; \qquad formula five$$

In which,

Iₙ represents the nth fringe pattern selected from generated sine fringe pattern,n=0, 1, 2, 3, . . . N−1;

(u,v) represents the pixel coordinate of the projected pattern, u is a horizontal ordinate, v is a vertical ordinate;

φ(u,v) represents a wrapping phase;

A represents a mean intensity;

B represents a modulated intensity;

N represents a total number of projected patterns;

mₙ represents sequences of the periodic edge codes, composed of 0 or 225; n represents rows of the sequence of the periodic edge codes;

k(u,v) represents stripe levels corresponding to (u,v);

Floor(u/p) represents a downward integer function, u represents a horizontal ordinate, p represents the number of pixels of a single-cycle stripe;

O(u,v) represents the number of the outliers in the sequence of the periodic edge codes;

D(u,v) represents a sequence type of the periodic edge code;

mₙ(u,v) represents the periodic edge code values.

In one embodiment, in the step C that comprises a projector for projecting and generating N pieces of fringe patterns to the surface of the object, and a camera for collecting N pieces of fringe patterns deformed on the surface of the object.

By using the formula six to show the fringe patterns collected by the camera:

$${I}_{n}^{′} ( x , y ) = \{ \begin{matrix}{A}^{′} + {B}^{′} cos [ φ ( x , y ) + \frac{2 n π}{N} ] \\ {m}_{n}^{′} ( x , y )\end{matrix} ; \qquad formula six$$

In which,

(x, y) represents the collected image pixel coordinate;

In′ represents the nth fringe pattern in the collected fringe patterns, n=0, 1, 2, 3, . . . N−1, N represents the total number of the collected fringe patterns;

A′ represents the mean intensity of the fringe patterns in the collected fringe pattern;

B′ represents the modulated intensity of the fringe pattern in the collected fringe pattern;

φ(x,y) represents the wrapping phase;

mₙ′ represents the sequence of the periodic edge codes of collected fringe patterns, n represents rows of the sequence of the periodic edge codes of collected fringe patterns.

In an embodiment, in the step D that comprises using a formula seven to solve the wrapping phase, using a formula eight to solve the mean intensity;

$$φ ( x , y ) = - arctan \frac{{Σ}_{n = 0}^{N - 1} {I}_{n}^{′} ( x , y ) sin ( \frac{2 n π}{N} )}{{Σ}_{n = 0}^{N - 1} {I}_{n}^{′} ( x , y ) cos ( \frac{2 n π}{N} )} ; \qquad formula seven$$

In which,

φ(x,y) represents the wrapping phase;

Iₙ′ represents the nth fringe pattern in the collected fringe patterns, n=0, 1, 2, 3, . . . N−1, N represents the total number of the collected fringe patterns;

(x,y) represents the pixel coordinates in the collected patterns.

In an embodiment, in the step D that comprises using formula eight to solve the mean intensity.

$${A}^{′} ( x , y ) = \frac{{Σ}_{n = 0}^{N - 1} {I}_{n}^{′} ( x , y )}{N} ; \qquad formula eight$$

In which,

Iₙ′ represents the nth fringe pattern in the collected fringe patterns, n=0, 1, 2, 3, . . . N−1, N represents the total number of the collected fringe patterns;

(x,y) represents the pixel coordinate of the collected fringe patterns;

A′(x,y) represents the mean intensity.

In an embodiment, in the step E that comprises using formula nine and formula ten to extract all the edge coordinates;

$$C ( x , y ) = \frac{{A}^{′} ( x , y )}{Median [ {A}^{′} ( x , y ) ]} ; \qquad formula nine$$

$${Mask}_{e d g e} ( x , y ) = \frac{{A}^{′} ( x , y )}{Median [ {A}^{′} ( x , y ) ]} ∉ ( 1 - T , 1 + T ) ; \qquad formula ten$$

In which,

C (x, y) represents a neighbourhood scale factor;

A′(x, y) represents the mean intensity;

Median [.] represents a median filtering function;

Maskedge (x, y) represents a bitmask of the periodic edge;

T represents a proportion threshold of extracting edge area.

In an embodiment, in the step F that comprises using the three-dimensional code of the left and right edges to determine the stripe level of each pixel of the wrapping phase, to obtain the absolute phase, comprising:

Step F1: sequentially decoding the sequence type of the periodic edge codes and the outlier sequence number according to the formula eleven and formula twelve;

$$\begin{matrix}{D}^{′} ( {x}_{e} , {y}_{e} ) = C ( {x}_{e} , {y}_{e} ) > 1 & ( {x}_{e} , {y}_{e} ) ∈ \{ {Mask}_{e d g e} ( x , y ) = 1 \} ;\end{matrix} \qquad formula eleven$$

$${O}^{′} ( {x}_{e} , {y}_{e} ) = \{ \begin{matrix}Find Min [ {I}_{0}^{′} ( {x}_{e} , {y}_{e} ) , … , {I}_{N - 1}^{′} ( {x}_{e} , {y}_{e} ) ] & {D}^{′} ( {x}_{e} , {y}_{e} ) = 1 \\ Find Max [ {I}_{0}^{′} ( {x}_{e} , {y}_{e} ) , … , {I}_{N - 1}^{′} ( {x}_{e} , {y}_{e} ) ] & {D}^{′} [ {x}_{e} , {y}_{e} ) = 0\end{matrix} ; \qquad formula twelve$$

In which,

D′(xₑ,yₑ) represents the type of the sequence of the periodic edge codes of the fringe pattern;

(xₑ,yₑ) represents the coordinate of the periodic edge;

c(xₑ, yₑ) represents the neighbourhood scale factor;

Mask_{edge}(x,y) represents the bitmask of the periodic edge;

O′(xₑ,yₑ) represents the sequence number of the outlier of the periodic edge codes of the fringe pattern;

FindMin[.] represents a function of returning a minimum value index;

FindMax [.] represents a function of returning a maximum value index;

In′ represents the nth fringe pattern in the collected fringe pattern, n=0, 1, 2, 3, . . . N−1, N represents the total number of the collected fringe patterns.

Step F2: obtaining two left and right nearest edge coordinates of each pixel according to the formula thirteen and formula fourteen, converting the three-dimensional codes corresponding to the two edge coordinates into a decimal code, determining the stripe level of the current pixel.

xₗ=Findmin[x−xₛ] xₛϵ{Mask_{edge}(xₛ,y)=1,xₛ<x} formula thirteen;

xᵣ=Findmin[xₛ−x] xₛϵ{Mask_{edge}(xₛ,y)=1,xₛ>x} formula fourteen;

In which,

xₗ represents the nearest edge coordinate point, (x,y) disposed on the left side of the fringe pattern, x represents the transverse ordinate, y represents the vertical ordinate;

xᵣ represents the nearest edge coordinate point, (x,y) disposed on the right side of the fringe pattern, x represents the transverse ordinate, y represents the vertical ordinate;

FindMin[.] represents a function of returning a minimum index;

xₛ represents a bitmask of the periodic edge; Mask_{edge}(x,y) represents a certain pixel coordinate of the coordinate pattern, namely, finding nearest two edges in the coordinate pattern; xₛ is the coordinate of the edge.

Step F3: calculating the decimal code based on the three-dimensional code of the left and right edges, determining the stripe level of each pixel based on the formula fifteen, obtaining the absolute phase based on the formula sixteen via pixel-by-pixel unwrapping.

$$k ( x , y ) = \{ \begin{matrix}\begin{matrix}2 \times \{ [ {0}^{′} ( {x}_{n}^{l} , y ) ] \times N + \\ {O}^{′} ( {x}_{n}^{r} , y ) + 1 \} - 1\end{matrix} & {D}^{′} ( {x}_{n}^{l} , y ) < {D}^{′} ( {x}_{n}^{r} , y ) \\ \begin{matrix}2 \times \{ \{ {O}^{′} ( {x}_{n}^{r} , y ) ] \times N + \\ mod [ {O}^{′} ( {x}_{n}^{l} , y ) + 1 , N ] \}\end{matrix} & {D}^{′} ( {x}_{n}^{l} , y ) > {D}^{′} ( {x}_{n}^{r} , y )\end{matrix} ; \qquad formula fifteen$$

$$∅ ( x , y ) = φ ( x , y ) + 2 π \times k ( x , y ) ; \qquad formula sixteen$$

In which,

k (x, y) represents the dot (x, y) obtained by calculating the stripe level sequence;

O′(xₙ^{l},y) represents the sequence number of the outliers in the periodic edge codes of the fringe pattern; (xₙ^{l},y) represents the nearest edge coordinate in the points (x, y) on a left side of the fringe pattern, n=0, 1, 2, 3, . . . N−1, N represents the total number of points from the collected fringe pattern.

O′(xₙ^{r},y) represents the sequence number of the outlier in the periodic edge codes of the fringe pattern, (xₙ^{r},y) represents the nearest edge coordinate of the points (x, y) at the right side of the n-th collected fringe pattern, n=0, 1, 2, 3, . . . N−1, N represents the total number of the collected fringe pattern.

D′(xₙ^{l},y) represents the type of the sequence of the periodic edge codes of the fringe pattern, (xₙ^{l},y) represents the nearest edge coordinate among the points (x, y), on the left side of the collected fringe pattern, n=0, 1, 2, 3, . . . N−1, N represents the total number of the collected fringe pattern.

D′(xₙ^{r},y) represents the sequence type of the periodic edge codes of the fringe pattern, (xₙ^{r},y) represents the nearest edge coordinate in points (x, y) at the right side of the n-th collected fringe pattern, n=0, 1, 2, 3, . . . N−1, N represents the total number of the collected fringe pattern;

mod [.] represents a remainder function.

ø(x,y) represents the absolute phase of the points (x, y).

φ(x,y) represents the wrapping phase of the point (x, y).

A three-dimensional measuring system for modulating three-dimensional codes at periodic edges, applying any one of the aforementioned three-dimensional measuring method for modulating three-dimensional codes on the periodic edges, the system comprising:

a first module, configured for based on a total number of the phase levels and a composition rule of the three-dimensional codes, converting the total number of phase levels into the three-dimensional codes, the three-dimensional codes are modulated to the period edges;

a second module, configured for generating N pieces of modulated three-dimensional codes on the periodic edges to form sinusoidal fringe patterns according to N-step phase shift method;

a third module, configured for projecting and generating N pieces of fringe patterns to the surface of the object, collecting N pieces of deformed fringe patterns on the surface of the object;

a fourth module, configured for solving the wrapped phase and the mean intensity of the collected N pieces of fringe patterns according to a N-step phase shift method;

a fifth module, configured for according to the different mean intensities of the periodic edges and the different features of adjacent periodic edges, using an edge extraction method to extract all the edge coordinates based on the mean intensities;

a sixth module, configured for using the three-dimensional coding of the left and right edges, determining the stripe level of each pixel of the wrapping phase, obtaining the absolute phase by unwrapping the pixel by pixel;

a seventh module, configured for reconstructing three-dimensional point cloud according to the triangular distance, constructing three-dimensional model of the object.

The technical effects of the technical solution of the present application are as follows:

The present application determines the stripe level of each pixel through the extraction of the periodic edge coordinates and solving of the left and right edge three-dimensional codes, to solve the absolute phases via pixel by pixel, which realizes utilizing a small amount of patterns to finish the three-dimensional measurement. The method utilizes less number of fringe patterns to be projected, which is one in third of the number of projected patterns by utilizing conventional N-step phase shift methods combined with three-frequency heterodyne decladding phase, is half of the number of projected patterns by utilizing the phase shift coding method, with fast phase-unwrapping speed, high efficiency for point cloud reconstruction.

### BRIEF DESCRIPTION OF THE DRAWINGS

FIG. 1 is a schematic flow chart of a three-dimensional measurement method of the structural light for modulating the three-dimensional code to the periodic edges according to one embodiment of the present application;

FIG. 2 is a schematic diagram of evolution according to one embodiment of the present application;

FIG. 3 is a schematic diagram of coding according to one embodiment of the present application;

FIG. 4 is a schematic diagram of a three-dimensional measurement system for the structural light in which the modulation of three-dimensional codes of the periodic edges according to one embodiment of the present application.

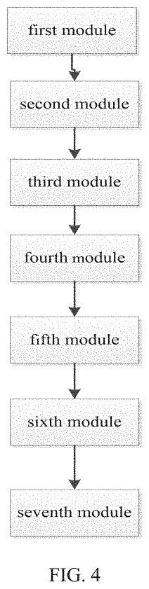

### DETAILED DESCRIPTION

The technical solution of the present application are further elaborated hereinafter with specific embodiments.

The present application provides a three-dimensional measuring method for modulating three-dimensional codes on periodic edges. Based on the coding method, the modulated three-dimensional codes are fused into the period edges, generating N pieces of modulated fringe patterns according to N-step phase shift method. The present application uses N-step phase shift method to solve the wrapping phase and mean intensity. Based on the feature that the mean intensities and the adjacent periodic edges are different, the method uses the edge detection algorithm to extract all edge coordinates, and based on the extracted edge coordinates, each period edge has three-dimensional codes composed of N pieces of fringe patterns. For each pixel of the wrapping phase, the three-dimensional codes located around the left and right edges are used to calculate the stripe level k of the pixel, to obtain the absolute phase by unwrapping the pixel by pixel. Finally method comprises reconstructing the three-dimensional point cloud according to the triangular distance measurement, constructing the three-dimensional model of the object, and finishing the three-dimensional measurement of the object.

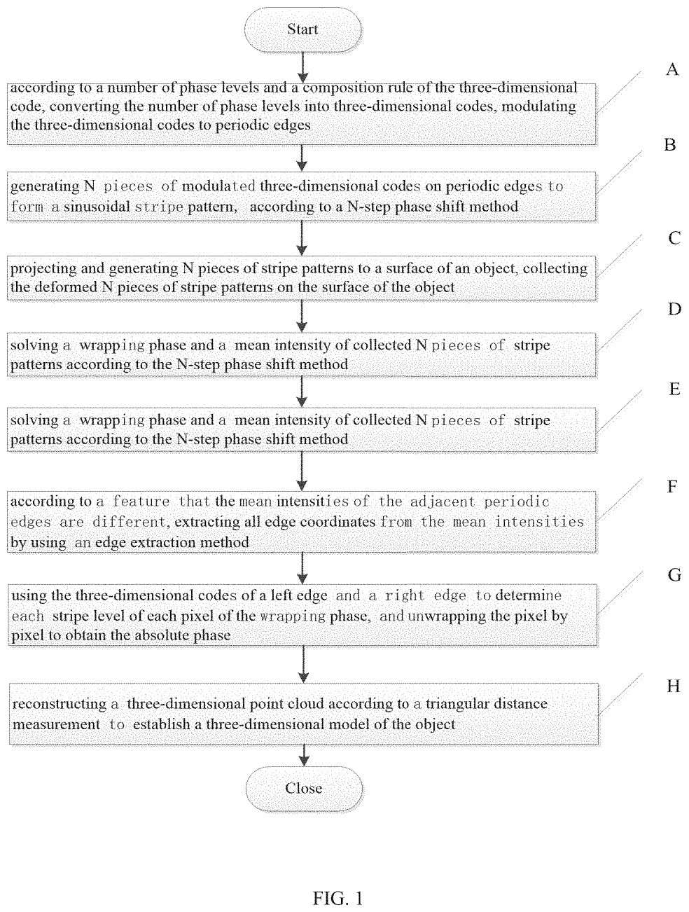

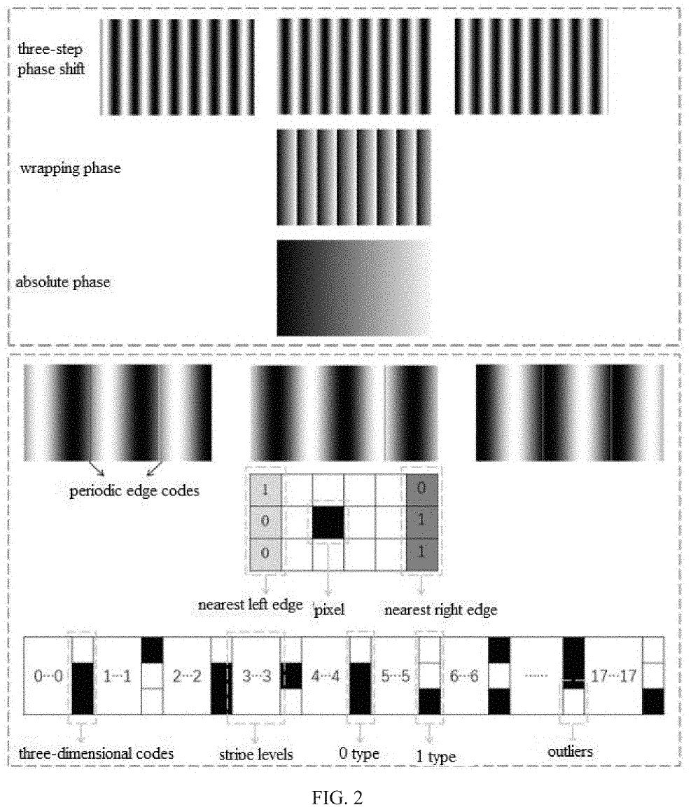

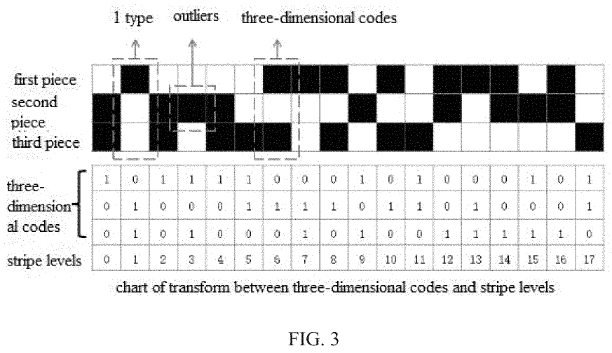

Specifically, as shown in FIG. 1 to FIG. 3, a three-dimensional measuring method for modulating three-dimensional codes on the periodic edges, comprising the following steps:

Step A: according to a number of phase levels and a composition rule of the three-dimensional code, converting the number of phase levels into three-dimensional codes, modulating the three-dimensional codes to periodic edges;

Step B: generating N pieces of modulated three-dimensional codes on periodic edges to form a sinusoidal fringe pattern, according to the N-step phase shift method;

Step C: projecting and generating N pieces of fringe patterns to the surface of the object, collecting the deformed N pieces of fringe patterns on the surface of the object;

Step D: solving a wrapping phase and a mean intensity of collected N pieces of fringe patterns according to the N-step phase shift method;

Step E: according to a feature that the mean intensities of the adjacent periodic edges are different, extracting all edge coordinates from the mean intensities by using an edge extraction method;

Step F: using the three-dimensional codes of the left edge and the right edge to determine each stripe level of each pixel of the wrapping phase, and unwrapping the pixel by pixel to obtain the absolute phase;

Step G: reconstructing a three-dimensional point cloud according to a triangular distance measurement to establish a three-dimensional model of the object.

In an embodiment, in the step A, the method comprises:

In projected N pieces of fringe patterns, the pixel of each period edge has N values, each value is 0 or 255, determining outliers from the N values.

Determining the sequence type of the periodic edge codes based on the outliers, and determining the outlier sequence number based on the position of the outlier located in the sequence of the periodic edge codes.

In an embodiment, when the outlier is 0, the periodic edge is 1 type, when the outlier is 1, the periodic edge is 0 type.

In an embodiment, the code sequences of adjacent periodic edges are different, thus combination types of two left and right periodic edges of a certain pixel are 0 type and 1 type, or 1 type and 0 type.

In which, 1 type of the outlier sequence number is configured for representing the position of the outlier in the periodic edge code sequence, amount to N kinds.

0 type of the outlier sequence number is configured for representing systems, amount to N systems.

N type of the outlier sequence number is representing N times of N systems, namely, by using the three-dimensional coding method, the periodic edges are divided into 2 kinds of types.

In this embodiment, specifically, in the step A, the method comprises converting the total number of phase levels into three-dimensional codes and modulating three-dimensional codes on the period edge. The rule for modulating the three-dimensional codes on the periodic edge is as follows: since there are N pieces of fringe patterns projected, the pixel of each period edge has N code values accordingly, each value can be 0 or 255, of which, there are 1 special code value is different compared to the rest N−1 of code values. In embodiments of the present application, the special code value is called an outlier that determines the sequence type, and also, the position of the outlier in the sequence is an outlier sequence number, if the outlier sequence number is 0, the edge codes having the outlier is 1 type, if the outlier is 1, then the edge codes is 0 type. In the present application, the types of the adjacent edge codes are different, the combination types of two left and right edge codes of a certain pixel may be 0 type and 1 type, or 1 type and 0 type; totally, there are 2 types, 1 type of the outlier sequence number is configured for representing the position of the outlier in the code sequence, which has N types; O type of the outlier sequence number is configured for representing the system, which has N systems accordingly, the outlier sequence number has N kinds, corresponding to N times of N systems, namely, by using the three-dimensional coding method, the periodic edges are divided into 2 kinds of types.

In an embodiment, in the step B, by using the N-step phase shift method to generate N pieces of modulated three-dimensional codes on the periodic edges to form the sinusoidal fringe pattern, comprising:

Referring to formulas one to five sequentially representing projected fringe patterns, stripe levels, sequence types of periodic edge code value, the outlier sequence numbers and periodic edge code values.

$${I}_{n} ( u , v ) = \{ \begin{matrix}A + B cos [ φ ( u , v ) + \frac{2 n π}{N} ] & mod [ φ ( u , v ) , 2 π ] \neq 0 \\ {m}_{n} ( u , v ) & mod [ φ ( u , v ) , 2 π ] = 0\end{matrix} ; \qquad formula one$$

$$k ( u , v ) = ( \frac{u}{P} ) ; \qquad formula two$$

$$D ( u , v ) = mod [ k ( u , v ) , 2 ] ; \qquad formula three$$

$$O ( u , v ) = \{ \begin{matrix}mod \{ \frac{k ( u , v ) - 1}{2} , N \} & D ( u , v ) = 1 \\ Floor [ \frac{k ( u , v )}{2 N} ] & D ( u , v ) = 0\end{matrix} ; \qquad formula four$$

$${m}_{n} ( u , v ) = \{ \begin{matrix}2 \; 55 \times [ 1 - D ( u , v ) ] & n = O ( u , v ) \\ 255 \times D ( u , v ) & else\end{matrix} ; \qquad formula five$$

In which,

Iₙ represents the nth fringe pattern selected from generated sine fringe pattern,n=0, 1, 2, 3, . . . N−1;

(u,v) represents the pixel coordinate of the projected pattern, u is a horizontal ordinate, v is a vertical ordinate;

φ(u,v) represents the wrapping phase;

A represents the mean intensity;

B represents the modulated intensity;

N represents the total number of projected patterns;

mₙ represents the sequence of the periodic edge codes, composed of 0 or 225, n represents the row of the sequence of the periodic edge codes;

k(u,v) represents the stripe levels corresponding to (u,v);

Floor(u/p) represents a downward integer function, u represents the horizontal ordinate, p represents the number of pixels of a single-cycle stripe;

O(u,v) represents the number of the outliers in the periodic edge code sequence;

D(u,v) represents the type of the periodic edge code sequence;

mₙ(u,v) represents the periodic edge code values.

In an embodiment of the present application, in the step C that comprises a projector for projecting and generating N pieces of fringe patterns onto the surface of the object, and a camera for collecting N pieces of fringe patterns deformed on the surface of the object;

By using formula six to show the fringe patterns collected by the camera:

$${I}_{n}^{′} ( x , y ) = \{ \begin{matrix}{A}^{′} + {B}^{′} cos [ φ ( x , y ) + \frac{2 n π}{N} ] \\ {m}_{n}^{′} ( x , y )\end{matrix} ; \qquad formula six$$

In which,

(x, y) represents the collected image pixel coordinate;

In′ represents the nth fringe pattern in the collected fringe patterns, n=0, 1, 2, 3, . . . N−1, N represents the total number of the collected fringe patterns;

A′ represents the mean intensity of the fringe patterns in the collected fringe pattern;

B′ represents the modulated intensity of the fringe pattern in the collected fringe pattern;

φ(x,y) represents wrapping phase;

mₙ′ represents the sequence of the periodic edge codes of collected fringe patterns, n represents the row number of the sequence of the periodic edge codes of collected fringe patterns.

In an embodiment, in the step D that comprises using formula eight to solve the mean intensity.

$${A}^{′} ( x , y ) = \frac{{Σ}_{n = 0}^{N - 1} {I}_{n}^{′} ( x , y )}{N} ; \qquad formula eight$$

In which,

Iₙ′ represents the nth fringe pattern in the collected fringe patterns, n=0, 1, 2, 3, . . . N−1, N represents the total number of the collected fringe patterns;

(x,y) represents the pixel coordinate of the collected fringe patterns;

A′(x,y) represents the mean intensity.

In an embodiment, in the step E that comprises using formula nine and formula ten to extract all the edge coordinates;

$$C ( x , y ) = \frac{{A}^{′} ( x , y )}{Median [ {A}^{′} ( x , y ) ]} ; \qquad formula nine$$

$${Mask}_{e d g e} ( x , y ) = \frac{{A}^{′} ( x , y )}{Median [ {A}^{′} ( x , y ) ]} ∉ ( 1 - T , 1 + T ) ; \qquad formula ten$$

In which,

C (x, y) represents a neighbourhood scale factor;

A′(x, y) represents the mean intensity;

Median [.] represents a median filtering function;

Maskedge (x, y) represents the bitmask of the periodic edge;

T represents a proportion threshold of extracting edge area.

In an embodiment, in the step E that comprises using formula nine and formula ten to extract all edge coordinates;

$$C ( x , y ) = \frac{{A}^{′} ( x , y )}{Median [ {A}^{′} ( x , y ) ]} ; \qquad formula nine$$

$${Mask}_{e d g e} ( x , y ) = \frac{{A}^{′} ( x , y )}{Median [ {A}^{′} ( x , y ) ]} ∉ ( 1 - T , 1 + T ) ; \qquad formula ten$$

In which,

C (x, y) represents a neighbourhood scale factor;

A′(x, y) represents the mean intensity;

Median [.] represents a median filtering function;

Maskedge (x, y) represents the bitmask of the periodic edge;

T represents a proportion threshold of extracting edge area.

In an embodiment, in the step F that comprises using the three-dimensional code of the left and right edges to determine the stripe level of each pixel of the wrapping phase, to obtain the absolute phase, comprising:

Step F1: sequentially decoding the sequence type of the periodic edge codes and the outlier sequence number according to the formula eleven and formula twelve;

$$\begin{matrix}{D}^{′} ( {x}_{e} , {y}_{e} ) = C ( {x}_{e} , {y}_{e} ) > 1 & ( {x}_{e} , {y}_{e} ) ∈ \{ {Mask}_{e d g e} ( x , y ) = 1 \}\end{matrix} ; \qquad formula eleven$$

$${O}^{′} ( {x}_{e} , {y}_{e} ) = \{ \begin{matrix}FindMin [ {I}_{0}^{′} ( {x}_{e} , {y}_{e} ) , … , {I}_{N - 1}^{′} ( {x}_{e} , {y}_{e} ) ] & {D}^{′} ( {x}_{e} , {y}_{e} ) = 1 \\ FindMax [ {I}_{0}^{′} ( {x}_{e} , {y}_{e} ) , … , {I}_{N - 1}^{′} ( {x}_{e} , {y}_{e} ) ] & {D}^{′} ( {x}_{e} , {y}_{e} ) = 0\end{matrix} ; \qquad formula twelve$$

In which,

D′(xₑ,yₑ) represents the sequence type of the periodic edge codes of the fringe pattern;

(xₑ, yₑ) represents the coordinate of the periodic edge;

C(xₑ, yₑ) represents the neighbourhood scale factor;

Mask_{edge}(x,y) represents the bitmask of the periodic edge;

O′(xₑ,yₑ) represents the outlier sequence number of the sequence of the periodic edge codes of the fringe pattern;

FindMin[.] represents a function of returning a minimum value index;

FindMax [.] represents a function of returning a maximum value index;

In′ represents the nth fringe pattern in the collected fringe patterns, n=0, 1, 2, 3, . . . N−1, N represents the total number of the collected fringe patterns.

Step F2: obtaining two left and right nearest edge coordinates of each pixel according to the formula thirteen and formula fourteen, converting the three-dimensional codes corresponding to the two edge coordinates into a decimal code, determining the stripe level of the current pixel.

xₗ=Findmin[x−xₛ] xₛϵ{Mask_{edge}(xₛ,y)=1,xₛ<x} formula thirteen;

xᵣ=Findmin[xₛ−x] xₛϵ{Mask_{edge}(xₛ,y)=1,xₛ>x} formula fourteen;

In which,

xₗ represents the nearest edge coordinate point, (x,y) disposed on the left side of the fringe pattern, x represents the transverse ordinate, y represents the vertical ordinate;

xᵣ represents the nearest edge coordinate point, (x,y) disposed on the right side of the fringe pattern, x represents the transverse ordinate, y represents the vertical ordinate;

FindMin[.] represents a function of returning a minimum index;

xₛ represents a bitmask of the periodic edge; Mask_{edge}(x,y) represents a certain pixel coordinate of the coordinate pattern, namely, finding nearest two edges in the coordinate pattern; xₛ is the coordinate of the edge.

Step F3: calculating the decimal code based on the three-dimensional code of the left and right edges, determining the stripe level of each pixel based on the formula fifteen, obtaining the absolute phase based on the formula sixteen via pixel-by-pixel unwrapping.

$$k ( x , y ) = \{ \begin{matrix}\begin{matrix}2 \times \{ [ {0}^{′} ( {x}_{n}^{l} , y ) ] \times N + \\ {O}^{′} ( {x}_{n}^{r} , y ) + 1 \} - 1\end{matrix} & {D}^{′} ( {x}_{n}^{l} , y ) < {D}^{′} ( {x}_{n}^{r} , y ) \\ \begin{matrix}2 \times \{ \{ {O}^{′} ( {x}_{n}^{r} , y ) ] \times N + \\ mod [ {O}^{′} ( {x}_{n}^{l} , y ) + 1 , N ] \}\end{matrix} & {D}^{′} ( {x}_{n}^{l} , y ) > {D}^{′} ( {x}_{n}^{r} , y )\end{matrix} ; \qquad formula fifteen$$

$$∅ ( x , y ) = φ ( x , y ) + 2 π \times k ( x , y ) ; \qquad formula sixteen$$

In which,

k (x, y) represents the dot (x, y) obtained by calculating the stripe level sequence;

O′(xₙ^{l},y) represents the sequence number of the outliers in the periodic edge codes of the fringe pattern; (xₙ^{l},y) represents the nearest edge coordinate in the points (x, y) on a left side of the fringe pattern, n=0, 1, 2, 3, . . . N−1, N represents the total number of points from the collected fringe pattern.

o′(xₙ^{r},y) represents the sequence number of the outliers in the periodic edge codes of the fringe pattern, (xₙ^{r},y) represents the nearest edge coordinate of the points (x, y) at the right side of the n-th collected fringe pattern, n=0, 1, 2, 3, . . . N−1, N represents the total number of the collected fringe pattern.

D′(xₙ^{l},y) represents the sequence type of the periodic edge codes of the fringe pattern, (xₙ^{l},y) represents the nearest edge coordinate among the points (x, y), on the left side of the collected fringe pattern, n=0, 1, 2, 3, . . . N−1, N represents the total number of the collected fringe pattern.

D′(xₙ^{r},y) represents the sequence type of the periodic edge codes of the fringe pattern, (xₙ^{r},y) represents the nearest edge coordinate in points (x, y) at the right side of the n-th collected fringe pattern, n=0, 1, 2, 3, . . . N−1, N represents the total number of the collected fringe pattern;

mod [.] represents a remainder function.

ø(x,y) represents the absolute phase of the points (x, y).

φ(x,y) represents the wrapping phase of the point (x, y).

A three-dimensional measuring system for modulating three-dimensional code at periodic edges, applying any one of the aforementioned three-dimensional measuring method for modulating three-dimensional code on the periodic edges, the system comprising:

a first module, configured for based on a total number of the phase levels and a composition rule of the three-dimensional codes, converting the total number of phase levels into the three-dimensional codes, the three-dimensional codes are modulated to the period edge;

a second module, configured for generating N pieces of modulated three-dimensional codes on the periodic edges to form sine fringe patterns according to N-step phase shift method;

a third module, configured for projecting and generating N pieces of fringe patterns to the surface of the object, collecting N pieces of deformed fringe patterns on the surface of the object;

a fourth module, configured for solving the wrapped phase and mean intensity of the collected N pieces of fringe patterns according to a N-step phase shift method;

a fifth module, configured for according to the different mean intensities of the periodic edges and the different features of adjacent periodic edges, using edge extraction method to extract all the edge coordinates based on the mean intensities;

a sixth module, configured for using the three-dimensional coding of the left and right edges, determining the stripe level of each pixel of the wrapping phase, obtaining the absolute phase by unwrapping the pixel by pixel;

a seventh module, configured for reconstructing three-dimensional point cloud according to the triangular distance, constructing three-dimensional model of the object.

The technical effects of the technical solution of the present application are as follows:

The present application determines the stripe level of each pixel through the extraction of the periodic edge coordinates and solving of the left and right edge three-dimensional codes, to solve the absolute phases via pixel by pixel, which realizes utilizing a small amount of patterns to finish the three-dimensional measurement. The method utilizes less number of fringe patterns to be projected, which is one in third of the number of projected patterns by utilizing conventional N-step phase shift methods combined with three-frequency heterodyne decladding phase, is half of the number of projected patterns by utilizing the phase shift coding method, with fast phase-unwrapping speed, high efficiency for point cloud reconstruction.

The above embodiments further illustrate the contents of the present application, but should not be construed as limiting the present application. Without departing from the spirit and essence of the present application, modifications and substitutions made to the methods, steps or conditions of the present application all fall within the scope of the present application. Unless particularly specified, the technical means used in the embodiments are conventional means well known to those skilled in the art.

What is claimed is:

1. A three-dimensional measuring method for modulating three-dimensional codes at periodic edges, comprising following steps:
step A: according to a number of phase levels and a composition rule of the three-dimensional codes, converting the number of phase levels into three-dimensional codes, modulating the three-dimensional codes to periodic edges;
step B: generating N pieces of modulated three-dimensional codes on periodic edges to form a sinusoidal fringe pattern, according to a N-step phase shift method;
step C: projecting and generating N pieces of fringe patterns to a surface of an object, collecting the deformed N pieces of fringe patterns on the surface of the object;
step D: solving a wrapping phase and a mean intensity of collected N pieces of fringe patterns according to the N-step phase shift method;
step E: according to a feature that the mean intensities of the adjacent periodic edge codes are different, extracting all edge coordinates from the mean intensities by using an edge extraction method;
step F: using the three-dimensional codes of a left edge and a right edge to determine each stripe level of each pixel of the wrapping phase, unwrapping the pixel by pixel to obtain an absolute phase;
step G: reconstructing a three-dimensional point cloud according to a triangular distance measurement to establish a three-dimensional model of the object.

2. The three-dimensional measuring method for modulating three-dimensional codes at periodic edges of claim 1, in the step A, the method comprises:
in projected N pieces of fringe patterns, the pixel of each period edge has N values accordingly, each value is 0 or 255, to determine outliers from the N values;
determining sequence types of the periodic edge codes by using outlier sequence numbers that are defined by positions of the outliers located in the sequence of the periodic edge codes.

3. The three-dimensional measuring method for modulating three-dimensional codes at periodic edges of claim 2, wherein
when the outlier is 0, the periodic edge is 1 type, when the outlier is 1, the periodic edge is 0 type;
the code sequences of adjacent periodic edges of a certain pixel are different, thus combination types of two left and right periodic edges of the pixel are 0 type and 1 type, or 1 type and 0 type;
wherein the outlier sequence number is 1 type, representing the position of the outlier in the periodic edge code sequence, amount to N kinds;
the outlier sequence number is 0 type, representing systems, amount to N systems;
the outlier sequence number is N type representing N times of N systems, namely, by using the three-dimensional coding method, the periodic edges are divided into 2 kinds of types.

4. The three-dimensional measuring method for modulating three-dimensional codes at periodic edges of claim 1, wherein in the step B, by using the N-step phase shift method to generate N pieces of modulated three-dimensional codes on the periodic edge to form the sinusoidal fringe pattern, comprising:
referring to formulas one to five sequentially representing projected fringe patterns, stripe levels, sequence types of periodic edge code value, the outlier sequence numbers and periodic edge code value;
$${I}_{n} ( u , v ) = \{ \begin{matrix}A + B cos [ φ ( u , v ) + \frac{2 n π}{N} ] & mod [ φ ( u , v ) , 2 π ] \neq 0 \\ {m}_{n} ( u , v ) & mod [ φ ( u , v ) , 2 π ] = 0\end{matrix} ; \qquad formula one$$
$$k ( u , v ) = ( \frac{u}{P} ) ; \qquad formula two$$
$$D ( u , v ) = mod [ k ( u , v ) , 2 ] ; \qquad formula three$$
$$O ( u , v ) = \{ \begin{matrix}mod \{ \frac{k ( u , v ) - 1}{2} , N \} & D ( u , v ) = 1 \\ Floor [ \frac{k ( u , v )}{2 N} ] & D ( u , v ) = 0\end{matrix} ; \qquad formula four$$
$${m}_{n} ( u , v ) = \{ \begin{matrix}2 \; 55 \times [ 1 - D ( u , v ) ] & n = O ( u , v ) \\ 255 \times D ( u , v ) & else\end{matrix} ; \qquad formula five$$
wherein: Iₙ represents the nth fringe pattern selected from generated sine fringe pattern, n=0, 1, 2, 3, . . . N−1;
(u,v) represents the pixel coordinate of the projected pattern, u is a horizontal ordinate, v is a vertical ordinate;
φ(u,v) represents the wrapping phase;
A represents a mean intensity;
B represents a modulated intensity;
N represents a total number of projected patterns;
mₙ represents a sequence of the periodic edge codes, composed of 0 or 225, n represents a row of the sequence of the periodic edge codes;
k(u, v) represents the stripe levels corresponding to (u,v);
Floor(u/p) represents a downward integer function, u represents a horizontal ordinate, p represents the number of pixels of a single-cycle stripe;
O(u,v) represents the number of the outliers in the periodic edge code sequence;
D(u,v) represents the type of the periodic edge code sequence;
mₙ(u,v) represents the periodic edge code values.

5. The three-dimensional measuring method for modulating three-dimensional codes at periodic edges of claim 1, wherein in the step C that comprises a projector for projecting and generating N pieces of fringe patterns to the surface of the object, and a camera for collecting N pieces of fringe patterns deformed on the surface of the object;
by using a formula six to show the fringe patterns collected by the camera;
$${I}_{n}^{′} ( x , y ) = \{ \begin{matrix}{A}^{′} + {B}^{′} cos [ φ ( x , y ) + \frac{2 n π}{N} ] \\ {m}_{n}^{′} ( x , y )\end{matrix} ; \qquad formula six$$
wherein, (x, y) represents a collected image pixel coordinate;
In′ represents a nth fringe pattern in the collected fringe patterns, n=0, 1, 2, 3, . . . N−1, N represents the total number of the collected fringe patterns;
A′ represents a mean intensity of the collected fringe patterns;
B′ represents a modulated intensity of the collected fringe patterns;
φ(x,y) represents a wrapping phase;
m′ represents a sequence of the periodic edge codes of collected fringe patterns, n represents rows of the sequence of the periodic edge codes of collected fringe patterns.

6. The three-dimensional measuring method for modulating three-dimensional codes at periodic edges of claim 1, wherein in the step D that comprises using a formula seven to solve the wrapping phase, using a formula eight to solve the mean intensity;
$$φ ( x , y ) = - arctan \frac{{Σ}_{n = 0}^{N - 1} {I}_{n}^{′} ( x , y ) sin ( \frac{2 n π}{N} )}{{Σ}_{n = 0}^{N - 1} {I}_{n}^{′} ( x , y ) cos ( \frac{2 n π}{N} )} ; \qquad formula seven$$
wherein, φ(x,y) represents the wrapping phase;
Iₙ′ represents the nth fringe pattern in the collected fringe patterns, n=0, 1, 2, 3, . . . N−1, N represents the total number of the collected fringe patterns;
(x,y) represents the pixel coordinates in the collected patterns.

7. The three-dimensional measuring method for modulating three-dimensional codes at periodic edges of claim 1, wherein in the step D that comprises using a formula eight to solve the mean intensity;
$${A}^{′} ( x , y ) = \frac{{Σ}_{n = 0}^{N - 1} {I}_{n}^{′} ( x , y )}{N} ; \qquad formula eight$$
wherein, Iₙ′ represents the nth fringe pattern in the collected fringe patterns, n=0, 1, 2, 3, . . . N−1, N represents the total number of the collected fringe patterns;
(x,y) represents the pixel coordinate of the collected fringe patterns;
A′(x,y) represents the mean intensity.

8. The three-dimensional measuring method for modulating three-dimensional codes at periodic edges of claim 1, wherein in the step E that comprises using a formula nine and a formula ten to extract all the edge coordinates;
$$C ( x , y ) = \frac{{A}^{′} ( x , y )}{Median [ {A}^{′} ( x , y ) ]} ; \qquad formula nine$$
$${Mask}_{e d g e} ( x , y ) = \frac{{A}^{′} ( x , y )}{Median [ {A}^{′} ( x , y ) ]} ∉ ( 1 - T , 1 + T ) ; \qquad formula ten$$
wherein, C (x, y) represents a neighbourhood scale factor;
A′(x, y) represents a mean intensity;
Median [.] represents a median filtering function;
Maskedge (x, y) represents a bitmask of the periodic edge;
T represents a proportion threshold of extracting edge area.

9. The three-dimensional measuring method for modulating three-dimensional codes at periodic edges of claim 1, wherein in the step E that comprises using the three-dimensional code of the left and right edges to determine the stripe level of each pixel of the wrapping phase, to obtain the absolute phase, comprising:
step F1: sequentially decoding the sequence type of the periodic edge codes and the outlier sequence number according to a formula eleven and a formula twelve;
$$\begin{matrix}{D}^{′} ( {x}_{e} , {y}_{e} ) = C ( {x}_{e} , {y}_{e} ) > 1 & ( {x}_{e} , {y}_{e} ) ∈ \{ {Mask}_{e d g e} ( x , y ) = 1 \}\end{matrix} ; \qquad formula eleven$$
$${O}^{′} ( {x}_{e} , {y}_{e} ) = \{ \begin{matrix}FindMin [ {I}_{0}^{′} ( {x}_{e} , {y}_{e} ) , … , {I}_{N - 1}^{′} ( {x}_{e} , {y}_{e} ) ] & {D}^{′} ( {x}_{e} , {y}_{e} ) = 1 \\ FindMax [ {I}_{0}^{′} ( {x}_{e} , {y}_{e} ) , … , {I}_{N - 1}^{′} ( {x}_{e} , {y}_{e} ) ] & {D}^{′} ( {x}_{e} , {y}_{e} ) = 0\end{matrix} ; \qquad formula twelve$$
wherein, D′(xₑ,yₑ) represents the type of the sequence of the periodic edge codes of the fringe pattern;
(xₑ, yₑ) represents the coordinate of the periodic edge;
C(xₑ, yₑ) represents the neighbourhood scale factor;
Mask_{edge}(x, y) represents the bitmask of the periodic edge;
O′(xₑ,yₑ) represents the sequence number of the outlier of the periodic edge codes of the fringe pattern;
FindMin[.] represents a function of returning a minimum value index;
FindMax [.] represents a function of returning a maximum value index;
In′ represents the nth fringe pattern in the collected fringe pattern, n=0, 1, 2, 3, . . . N−1, N represents the total number of the collected fringe patterns;
step F2: obtaining two left and right nearest edge coordinates of each pixel according to the formula thirteen and a formula fourteen, converting the three-dimensional codes corresponding to the two edge coordinates into a decimal code, determining the stripe level of the current pixel;
xₗ=Findmin[x−xₛ] xₛϵ{Mask_{edge}(xₛ,y)=1,xₛ<x} formula thirteen;
xᵣ=Findmin[xₛ−x] xₛϵ{Mask_{edge}(xₛ,y)=1,xₛ>x} formula fourteen;
wherein, xₗ represents the nearest edge coordinate point, (x,y) disposed on the left side of the fringe pattern, x represents a transverse ordinate, y represents a vertical ordinate;
xᵣ represents the nearest edge coordinate point, (x,y) disposed on the right side of the fringe pattern, x represents the transverse ordinate, y represents the vertical ordinate;
FindMin[.] represents a function of returning a minimum index;
xₛ represents a bitmask of the periodic edge; Mask_{edge}(x,y) represents a certain pixel coordinate of the coordinate pattern, namely, finding nearest two edges in the coordinate pattern; xₛ is the coordinate of the edge;
step F3: calculating the decimal code based on the three-dimensional codes of the left and right edges, determining the stripe level of each pixel based on a formula fifteen, obtaining the absolute phase based on a formula sixteen via pixel-by-pixel unwrapping;
$$k ( x , y ) = \{ \begin{matrix}\begin{matrix}2 \times \{ [ {0}^{′} ( {x}_{n}^{l} , y ) ] \times N + \\ {O}^{′} ( {x}_{n}^{r} , y ) + 1 \} - 1\end{matrix} & {D}^{′} ( {x}_{n}^{l} , y ) < {D}^{′} ( {x}_{n}^{r} , y ) \\ \begin{matrix}2 \times \{ \{ {O}^{′} ( {x}_{n}^{r} , y ) ] \times N + \\ mod [ {O}^{′} ( {x}_{n}^{l} , y ) + 1 , N ] \}\end{matrix} & {D}^{′} ( {x}_{n}^{l} , y ) > {D}^{′} ( {x}_{n}^{r} , y )\end{matrix} ; \qquad formula fifteen$$
$$∅ ( x , y ) = φ ( x , y ) + 2 π \times k ( x , y ) ; \qquad formula sixteen$$
wherein, k (x, y) represents the dot (x, y) obtained by calculating the stripe level sequence;
O′(xₙ^{l},y) represents the sequence number of the outlier in the periodic edge codes of the fringe pattern; (xₙ^{l},y) represents the nearest edge coordinate in the points (x, y) on a left side of the fringe pattern, n=0, 1, 2, 3, . . . N−1, N represents the total number of points from the collected fringe pattern;
O′(xₙ^{r},y) represents the sequence number of the outlier in the periodic edge codes of the fringe pattern, (xₙ^{r},y) represents the nearest edge coordinate of the points (x, y) at the right side of the n-th collected fringe pattern, n=0, 1, 2, 3, . . . N−1, N represents the total number of the collected fringe pattern;
D′(xₙ^{l},y) represents the type of the sequence of the periodic edge codes of the fringe pattern, (xₙ^{l},y) represents the nearest edge coordinate among the points (x, y), on the left side of the collected fringe pattern, n=0, 1, 2, 3, . . . N−1, N represents the total number of the collected fringe pattern;
D′(xₙ^{r},y) represents the sequence type of the periodic edge codes of the fringe pattern, (xₙ^{r},y) represents the nearest edge coordinate in points (x, y) at the right side of the n-th collected fringe pattern, n=0, 1, 2, 3, . . . N−1, N represents the total number of the collected fringe pattern;
mod [.] represents a remainder function;
ø(x,y) represents the absolute phase of the points (x, y);
φ(x,y) represents the wrapping phase of the point (x, y).

10. A three-dimensional measuring system for modulating three-dimensional codes at periodic edges, applying any one of the three-dimensional measuring method for modulating three-dimensional codes on the periodic edges according to claim 1, the system comprising:
a first module, configured for based on a total number of the phase levels and a composition rule of the three-dimensional codes, converting the total number of phase levels into the three-dimensional codes, the three-dimensional codes are modulated to the period edge;
a second module, configured for generating N pieces of modulated three-dimensional codes on the periodic edge to form sinusoidal fringe patterns according to a N-step phase shift method;
a third module, configured for projecting and generating N pieces of fringe patterns to the surface of the object, collecting N pieces of deformed fringe patterns on the surface of the object;
a fourth module, configured for solving the wrapped phase and the mean intensities of the collected N pieces of fringe patterns according to N-step phase shift method;
a fifth module, configured for according to the different mean intensities of the periodic edges and the different features of adjacent periodic edges, using an edge extraction method to extract all the edge coordinates based on the mean intensities;
a sixth module, configured for using the three-dimensional codes of the left and right edges, determining the stripe level of each pixel of the wrapping phase, obtaining the absolute phase by unwrapping the pixel by pixel;
a seventh module, configured for reconstructing three-dimensional point cloud according to the triangular distance, constructing a three-dimensional model of the object.
